(19) United States
(12) Patent Application Publication
(10) Pub. No.: US 2023/0259123 A1
(43) Pub. Date: Aug. 17, 2023

(54) REMOTE DRIVING SYSTEM, COMMUNICATION METHOD

(71) Applicant: Woven Planet Holdings, Inc., Tokyo (JP)

(72) Inventors: Yuki Suehiro, Ichikawa-shi (JP); Takahiro Ito, Tokyo-to (JP); Naoya Kaneko, Tokyo-to (JP)

(73) Assignee: Woven Planet Holdings, Inc., Tokyo (JP)

(21) Appl. No.: 18/080,256

(22) Filed: Dec. 13, 2022

(30) Foreign Application Priority Data
Feb. 14, 2022 (JP) 2022-020823

(51) Int. Cl. G05D 1/00; G08C 17/02; H04B 17/364

(52) U.S. Cl. CPC G05D 1/0022; G08C 17/02; H04B 17/364; G08C 2201/42; G08C 2201/63

(57) ABSTRACT

A system for providing remote driving by communication between a remote driving vehicle and a remote driving apparatus. The system executes selecting a communication line from a plurality of communication lines, transmitting time series data through the selected communication line between the remote driving vehicle and the remote driving apparatus, acquiring a communication environment information of the selected communication line, and switching the selected communication line based on the communication environment information. Wherein, the transmitting the time series data includes performing a transmission hold process when the selected communication line is switched, the transmission hold process being a process holding off start of transmitting the time series data through the selected communication line after switching until a delay time of the selected communication line before switching has elapsed from a time point of switching.

### CROSS-REFERENCE TO RELATED APPLICATION

The present application claims priority under 35 U.S.C. § 119 to Japanese Patent Application No. 2022-020823, filed Feb. 14, 2022, the contents of which application are incorporated herein by reference in their entirety.

### BACKGROUND

### Technical Field

The present disclosure relates to a technique for performing communication while switching communication lines. In particular, the present disclosure relates to a technique for performing communication between a remote driving vehicle and a remote driving apparatus.

### Background Art

Patent Literature 1 discloses a technique for improving communication quality in a mobile communication system, the technique includes switching to another communication line among a plurality of communication lines and continuing communication when a failure occurs in communication.

Patent Literature 2 discloses a technique regarding a routing protocol of a packet switching system comprising a plurality of packet switches and lines, the technique includes performing routings by automatically selecting a route in which a transfer delay time from a packet switch accommodating a source terminal to a packet switch accommodating a destination terminal is minimized.

### LIST OF RELATED ART

Patent Literature 1: Japanese Laid-Open Patent Application Publication No. JP-2018-093524

Patent Literature 2: Japanese Laid-Open Patent Application Publication No. JP-H09-321795

### SUMMARY

The switching a communication line is performed not only the case where a failure occurs in communication, but also to select a communication line which enables better communication. In this case, typically, the delay time of the communication line after switching is improved more than the delay time of the communication line before switching. Regarding communication between a remote driving vehicle and a remote driving apparatus in a remote driving system, the delay time is required to be as small as possible. Therefore, it is considered to apply a technique switching a communication line.

However, because of the delay time of the communication line after switching being improved compared to the delay time of the communication line before switching, there is a possibility that the data transmitted before and after switching is reversed and received on the reception side. If the data are reversed and received when transmitting time series data in a remote driving system, an unintended vehicle behavior may occur, and the safety of the vehicle may be deteriorated. In addition, an operator of remote driving may erroneously recognize that an abnormality occurs in the remote driving system due to the feeling of strangeness in the vehicle behavior.

In view of the above-described problem, an object of the present disclosure is to provide a technique capable of preventing data transmitted before and after switching of a communication line are reversed and received on a reception side.

A first disclosure is directed to a system for providing remote driving by communication between a remote driving vehicle and a remote driving apparatus.

The system comprises one or more processors configured to execute:

selecting a communication line from a plurality of communication lines capable of being formed between the remote driving vehicle and the remote driving apparatus;

transmitting time series data through the selected communication line between the remote driving vehicle and the remote driving apparatus;

acquiring a communication environment information of the selected communication line; and

switching the selected communication line based on the communication environment information,

wherein the transmitting the time series data through the selected communication line includes performing a transmission hold process when the selected communication line is switched, the transmission hold process being a process holding off start of transmitting the time series data through the selected communication line after switching until a delay time of the selected communication line before switching has elapsed from a time point of switching.

A second disclosure is directed to a system further having the following features with respect to the system according to the first disclosure.

The one or more processors are further configured to execute estimating the delay time of the selected communication line.

A third disclosure is directed to a system further having the following features with respect to the system according to the first disclosure.

The acquiring the communication environment information of the selected communication line includes acquiring a round-trip time of the selected communication line, and

the delay time of the selected communication line is half the round-trip time of the selected communication line.

A fourth disclosure is directed to a system further having the following features with respect to the system according to the first disclosure.

The system further comprises a memory storing information defining one or more specific categories for the time series data, and

the performing the transmission hold process is further conditioned on that the time series data belong to the one or more specific categories.

A fifth disclosure is directed to a method transmitting and receiving time series data through a selected communication line selected from a plurality of communication lines.

The method includes:

acquiring a communication environment information of the selected communication line;

switching the selected communication line based on the communication environment information; and

performing a transmission hold process when the selected communication line is switched, the transmission hold process being a process holding off start of transmitting the time series data through the selected communication line after switching until a delay time of the selected communication line before switching has elapsed from a time point of switching.

A sixth disclosure is directed to a system for providing remote driving by communication between a remote driving vehicle and a remote driving apparatus.

The system comprises one or more processors configured to execute:

selecting a communication line from a plurality of communication lines capable of being formed between the remote driving vehicle and the remote driving apparatus;

transmitting time series data through the selected communication line between the remote driving vehicle and the remote driving apparatus;

acquiring a communication environment information of the selected communication line; and

switching the selected communication line based on the communication environment information,

wherein the transmitting the time series data through the selected communication line includes performing a retransmission process when the selected communication line is switched, the retransmission process being a process retransmitting the time series data transmitted during the past by a delay time difference from a time point of switching, the delay time difference being a difference between a delay time of the selected communication line before switching and that after switching.

A seventh disclosure is directed to a system further having the following features with respect to the system according to the sixth disclosure.

The one or more processors are further configured to execute estimating the delay time of the selected communication line.

An eighth disclosure is directed to a system further having the following features with respect to the system according to the sixth disclosure.

The acquiring the communication environment information of the selected communication line includes acquiring a round-trip time of the selected communication line, and

the delay time of the selected communication line is half the round-trip time of the selected communication line.

A ninth disclosure is directed to a system further having the following features with respect to the system according to the sixth disclosure.

The system further comprises a memory storing information defining one or more specific categories for the time series data, and

the performing the retransmission process is further conditioned on that the time series data belong to the one or more specific categories.

According to the embodiment of the present disclosure, when a communication line is switched, the start of transmitting data through the communication line after switching is held off until a delay time of the communication line before switching has elapsed from a time point of switching. Alternatively, when a communication line is switched, data transmitted during the past by a delay time difference, which is a difference between a delay time of the communication line before switching and that after switching, from the time point of switching is retransmitted.

It is thus possible to, when time series data are transmitted, prevent that the time series data transmitted before and after switching are reversed and received on the reception side. As a result, it contributes to improvement of safety of a remote driving vehicle and improvement of operability of driving operation by an operator.

### BRIEF DESCRIPTION OF DRAWINGS

FIG. 1 is a conceptual diagram for explaining an outline of a remote driving system according to a first embodiment;

FIG. 2 is a conceptual diagram for explaining an outline of a communication apparatus;

FIG. 3 is a conceptual diagram for explaining an outline of a switching process;

FIG. 4 is a conceptual diagram showing an example of a case where data transmitted before and after switching of a communication line are reversed and received on a reception side;

FIG. 5 is a conceptual diagram for explaining an outline of a transmission hold process;

FIG. 6 is a diagram illustrating an example of a target data determination policy;

FIG. 7 is a block diagram showing a schematic configuration of a remote driving vehicle;

FIG. 8 is a block diagram showing a schematic configuration of a remote driving apparatus;

FIG. 9 is a block diagram showing a schematic configuration of a communication device;

FIG. 10 is a block diagram illustrating a configuration of processing executed by a transmission/reception processing unit when transmitting data;

FIG. 11 is a flowchart showing a communication method realized in a remote driving system according to the first embodiment;

FIG. 12 is a block diagram illustrating a configuration of processing executed by a transmission/reception processing unit according to a modification;

FIG. 13 is a conceptual diagram for explaining an outline of a retransmission process;

FIG. 14 is a block diagram illustrating a configuration of processing executed by a transmission/reception processing unit according to a second embodiment; and

FIG. 15 is a flowchart showing a communication method realized in a remote driving system according to the second embodiment.

### EMBODIMENTS

Hereinafter, an embodiment of the present disclosure will be described with reference to drawings. Note that when the numerals of the numbers, the quantities, the amounts, the ranges, and the like of the respective elements are mentioned in the embodiments shown as follows, the present disclosure is not limited to the mentioned numerals unless specially explicitly described otherwise, or unless the invention is explicitly specified by the numerals theoretically. Furthermore, structures or the like that are described in conjunction with the following embodiment is not necessarily essential to the concept of the present disclosure unless explicitly described otherwise, or unless the present disclosure is explicitly specified by the structures or the like theoretically. Note that in the respective drawings, the same or corresponding parts are assigned with the same reference signs, and redundant explanations of the parts are properly simplified or omitted.

### 1. First Embodiment

### 1-1. Outline

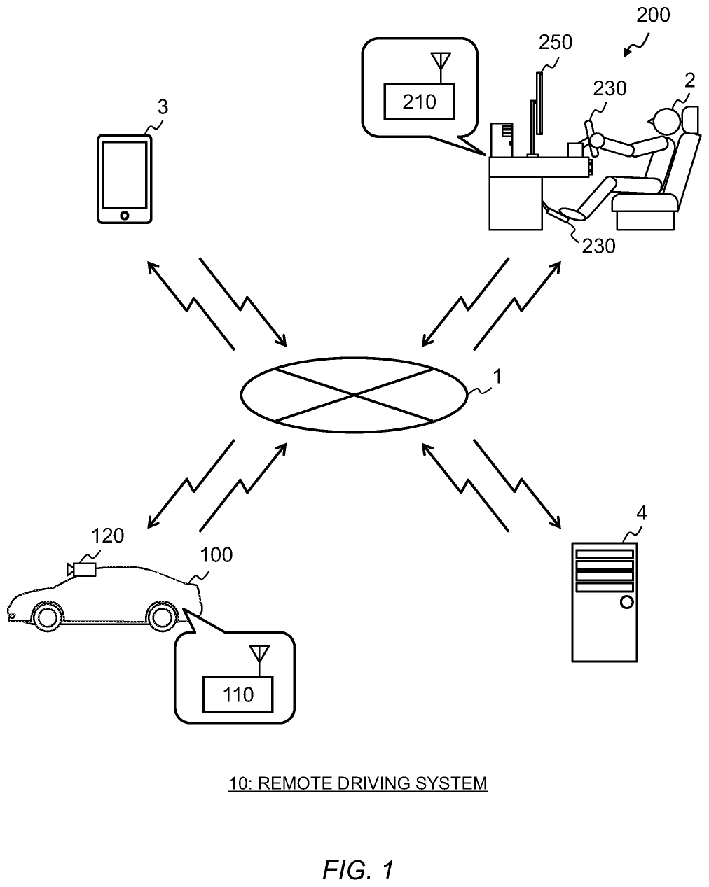

FIG. 1 is a conceptual diagram for explaining an outline of a remote driving system 10 according to the first embodiment. In the remote driving system 10, a remote driving vehicle 100 travels in accordance with driving operation of a remote driving apparatus 200 by an operator 2.

The remote driving apparatus 200 includes a display device 250 that displays a traveling video captured by a camera 120 mounted on the remote driving vehicle 100, and driving operation devices 230 that receives driving operation by the operator 2. The operator 2 recognizes a traveling environment of the remote driving vehicle 100 by watching the traveling video. Then the operator 2 operates the driving operation device 230. Further, the remote driving apparatus 200 may be configured to being that the operator 2 can hear sounds in or around the remote driving vehicle 100. In this case, for example, the remote driving vehicle 100 includes a microphone that collects sound inside or around the remote driving vehicle 100.

Here, communication between the remote driving vehicle 100 and the remote driving apparatus 200 is performed via a communication network 1. In other words, the remote driven vehicle 100 and the remote driven device 200 communicate through a communication line formed on the communication network 1. For example, the traveling video captured by the camera 120 is transmitted to the remote driving apparatus 200 through the communication line formed on the communication network 1. The driving operation received by the remote driving apparatus 200 is transmitted to the remote driving vehicle 100 through the communication line formed on the communication network 1. The communication network 1 is configured, for example, by a base station that performs wireless communication with the remote driving vehicle 100 and the Internet to which the base station is connected.

Examples of the communication line formed on the communication network 1 include a wireless communication channel, an Internet line, an optical line, an electric communication cable, and the like, or a combination thereof. The communication line can also be called “communication channel”.

The communication line between the remote driving vehicle 100 and the remote driving apparatus 200 may be partially shared by another device. For example, the channel through which the remote driving vehicle 100 communicates with the base station may be the same as the channel through which the mobile terminal 3 such as a smartphone communicates with the base station. When a plurality of remote driving vehicles each of which having the same configuration as the remote driving vehicle 100 is traveling, each of the plurality of remote driving vehicles may communicate with the base station through the same channel. Thus, the communication environment (congestion state, quality, and the like) of the communication line between the remote driving vehicle 100 and the remote driving apparatus 200 changes depending on the use state of the communication line. It is also conceivable that the communication environment of the communication line changes depending on the environment around the remote driving vehicle 100.

The communication environment of the communication line, for example, a round-trip time (RTT), latency, a bit error rate, a line utilization rate, or the like can be used as an index. The RTT and the latency can be measured by, for example, transmitting a measurement signal and receiving a response signal to the transmitted measurement signal.

A server 4 is connected to the communication network 1 shown in FIG. 1. The server 4 manages a communication environment information (RTT, latency, and the like) of a communication line formed on the communication network 1. The server 4 outputs the communication environment information of a communication line formed on the communication network 1 in response to a request. The server 4 may be configured to acquire the communication environment information from a device that performs communication on the communication network 1, or may be configured to calculate the communication environment information by transmitting a measurement signal or the like. The server 4 can also be called a “data center” or a “data server” to manage the communication environment information.

The remote driving vehicle 100 and the remote driving apparatus 200 include a communication device 110 and a communication device 210, respectively. Communication between the remote driving vehicle 100 and the remote driving apparatus 200 is realized by the communication device 110 and the communication device 210 performing data transmission/reception processing with each other. Here, the communication device 110 and the communication device 210 transmit and receive data to and from each other through one communication line selected from a plurality of communication lines capable of being formed on the communication network 1. Hereinafter, a communication line through which the communication device 110 and the communication device 210 transmit and receive data to and from each other is referred to as a “selected communication line”.

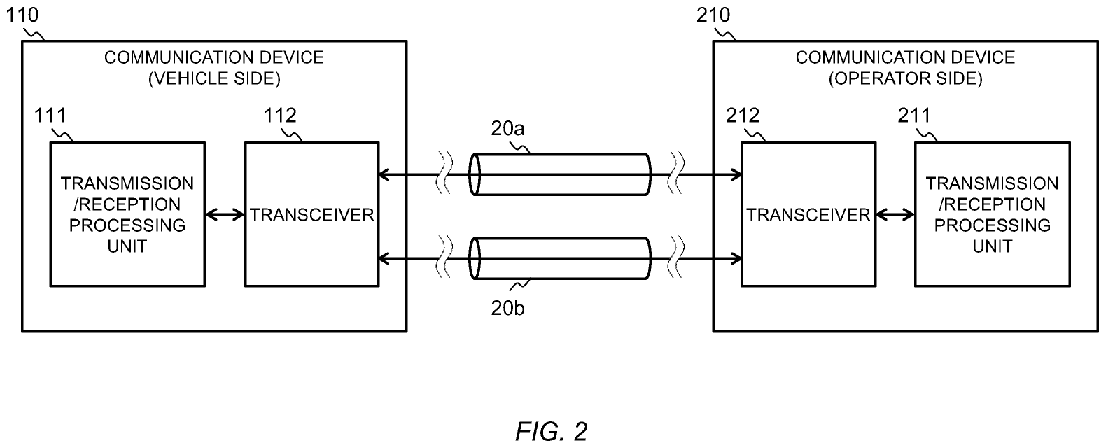

FIG. 2 is a conceptual diagram for explaining an outline of the communication apparatus 110 and the communication apparatus 210. The communication device 110 includes a transmission/reception processing unit 111 and a transceiver 112. Similarly, the communication device 210 includes a transmission/reception processing unit 211 and a transceiver 212. In FIG. 2, a first communication line 20a and a second communication line 20b, each of that is one of the plurality of communication lines capable of being formed on the communication network 1, are illustrated. In FIG. 2, the communication device 110 and the communication device 210 perform transmitting/receiving data with each other through either the first communication line 20a or the second communication line 20b as the selected communication line.

The transmission/reception processing unit 111 executes a transmission process which transmitting data by the transceiver 112 and a reception process which receiving data by the transceiver 112. The transmission process is, for example, a process of generating a transmission signal in accordance with a predetermined communication protocol. The reception process is, for example, a process of extracting data from a reception signal received by the transceiver 112 in accordance with the predetermined communication protocol. Similarly, the transmission/reception processing unit 211 executes a transmission process which transmitting data by the transceiver 212 and a reception process which receiving data by the transceiver 212.

The transceiver 112 transmits the transmission signal acquired from the transmission/reception processing unit 111 to the communication device 210 through the selected communication line. And the transceiver 112 acquires a signal transmitted from the communication device 210 as a reception signal. Similarly, the transceiver 212 transmits the transmission signal acquired from the transmission/reception processing unit 211 to the communication device 110. And the transceiver 212 acquires a signal transmitted from the communication device 110 as a reception signal.

The transceiver 112 and the transceiver 212 may adopt a known suitable configuration in accordance with an environment to which the remote driving system 10 according to the first embodiment is applied. For example, the transceiver 112 and the transceiver 212 are configured to transmit a radio wave modulated by a transmission signal by an antenna, and acquire a reception signal by demodulating a radio wave received by the antenna. Alternatively, the transceiver 112 or the transceiver 212 is configured to convert a transmission signal into an optical signal and transmit the optical signal, and convert a received optical signal to acquire a reception signal.

The transmission/reception processing unit 111 executes a process (hereinafter also referred to as “switching process”) switching the selected communication line in accordance with the communication environment information when transmitting data. The communication environment information may be acquired by the communication device 110 from the server 4 via the communication network 1 or may be calculated by transmission of a measurement signal or the like in the communication device 110. The switching process is typically performed to select a communication line having a small delay time as the selected communication line. For example, if the current selected communication line is the first communication line 20a, when the RTT of the first communication line 20a is greater than the RTT of the second communication line 20b, the selected communication line is switched from the first communication line 20a to the second communication line 20b. On the other hand, when the RTT of the first communication line 20a is smaller than the RTT of the second communication line 20b, the selected communication line remains the first communication line 20a. When switching the selected communication line by executing the switching process, the transmission/reception processing unit 111 generates a switching request signal requesting the transceiver 112 to switch the selected communication line. By operating the transceiver 112 in accordance with the switching request signal, the selected communication line for transmitting data is switched.

Similarly, the transmission/reception processing unit 211 executes the switching process when transmitting data. When switching the selected communication line by executing the switching process, the transmission/reception processing unit 211 generates a switching request signal requesting the transceiver 212 to switch the selected communication line.

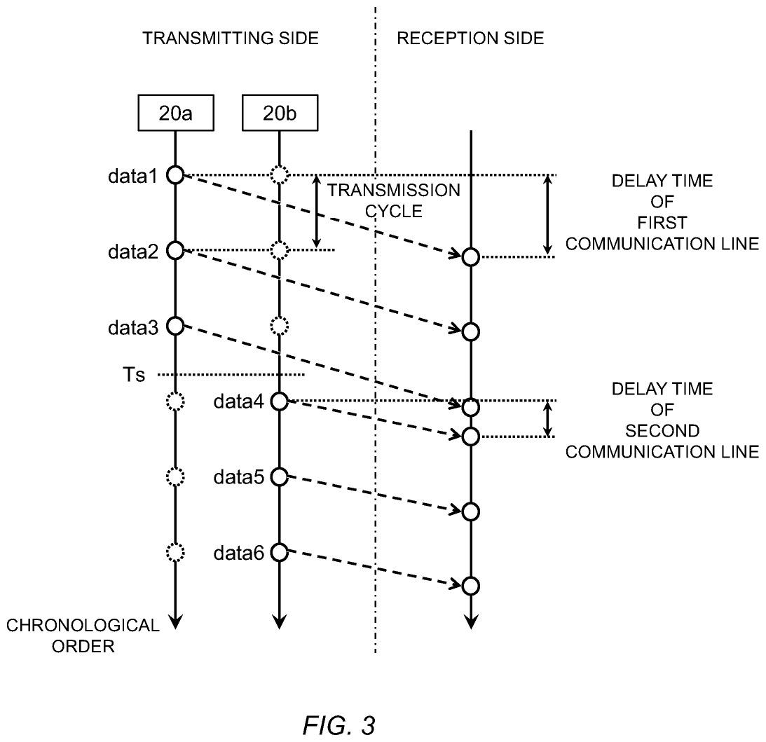

FIG. 3 is a conceptual diagram for explaining an outline of the switching process. FIG. 3 shows, in chronological order, a state in which the transmission side transmits multiple data (data1, data2, . . . , data6) at every predetermined transmission cycle and a state in which the reception side receives the transmitted data. In particular, FIG. 3 shows a case where the selected communication line is switched from the first communication line 20a to the second communication line 20b by the switching process at a time point Ts. In FIG. 3, the delay time of the second communication line 20b is smaller than the delay time of the first communication line 20a. Therefore, the delay time can be improved by executing the switching processing.

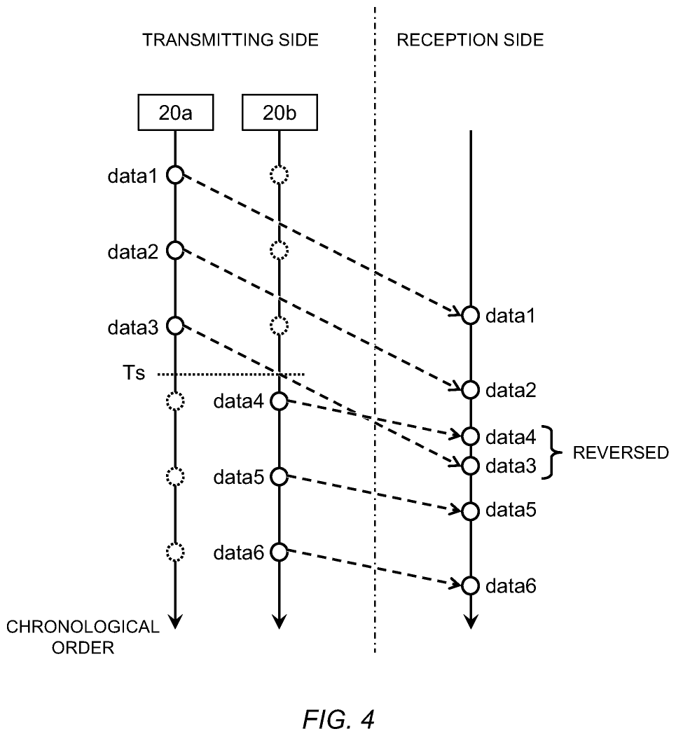

By the way, because of the delay time of the communication line after switching being improved compared to the delay time of the communication line before switching, there is a possibility that the data transmitted before and after switching is reversed and received on the reception side. FIG. 4 is a conceptual diagram illustrating an example of a case where data transmitted before and after switching is reversed and received on the reception side. FIG. 4 is a diagram similar to FIG. 3 and illustrates a case where the selected communication line is switched from the first communication line 20a to the second communication line 20b at a time point Ts. In FIG. 4, as a result of improvement of the delay time of the selected communication line, data3 and data4, which are transmitted before and after switching, are reversed and received on the reception side.

When data are time series data, if data transmitted before and after the switching are reversed and received on the reception side, a gap occurs between the data transmitted on the transmission side and the data received on the reception side. In particular, if time series data such as driving operation data (a steering angle, an accelerator operation amount, a brake operation amount, or the like) or traveling video is reversed and received on the reception side in the remote driving system 10, an unintended vehicle behavior may occur and the safety of the vehicle may be deteriorated. In addition, the operator 2 may erroneously recognize that an abnormality occurs in the remote driving system 10 due to the feeling of strangeness in the vehicle behavior.

Therefore, in the remote driving system 10 according to the first embodiment, the transmission/reception processing unit 111 and the transmission/reception processing unit 211 are configured to execute a transmission hold process when the selected communication line is switched by the switching process and transmitting data are time series data. The transmission hold process is a process holding off the start of transmitting data through the selected communication line after switching until a delay time of the selected communication line before switching has elapsed from a time point of switching.

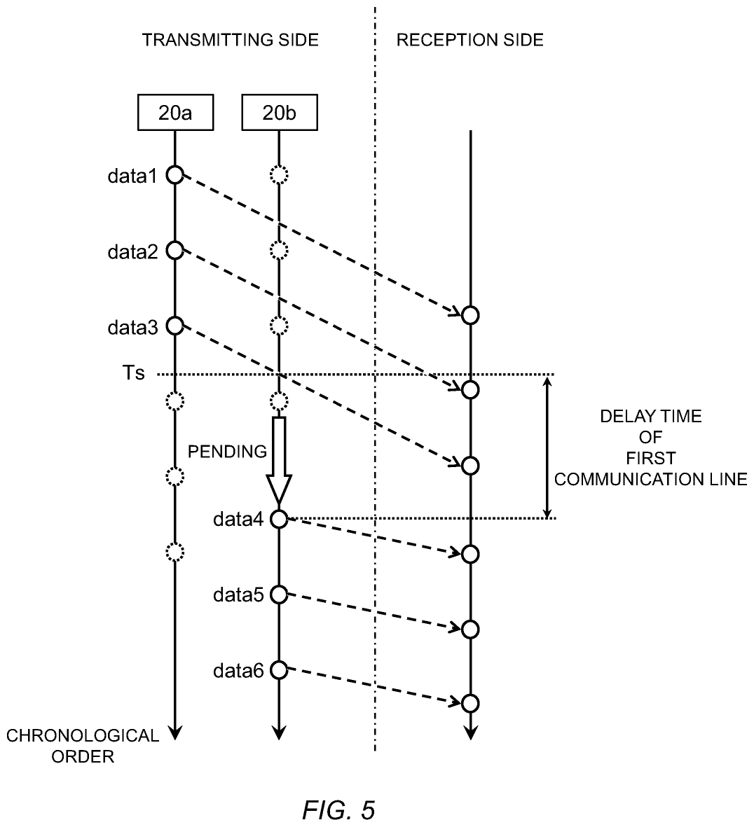

FIG. 5 is a conceptual diagram for explaining an outline of the transmission hold process. FIG. 5 is a diagram similar to FIG. 3 and illustrates a case where the selected communication line is switched from the first communication line 20a to the second communication line 20b at a time point Ts. In FIG. 5, it is assumed that data transmitted by the transmission side is time series data.

As illustrated in FIG. 5, by executing the transmission hold process, the start of transmitting data after switching is not performed at the timing according to the transmission cycle. That is, the start of transmitting data is held off until the delay time of the first communication line 20a has elapsed from the time point Ts. As a result, when transmitting time series data, it is possible to prevent the time series data transmitted before and after switching from being reversed and received on the reception side.

The transmission/reception processing unit 111 and the transmission/reception processing unit 211 may be configured to determine whether or not the transmitting data are a target time series data on which the transmission hold process is executed. Then, the transmission hold processing may be executed when determining that the transmitting data are the target time series data. Here, whether or not the transmitting data are the target series data on which the transmission hold process is executed may be determined based on a “target data determination policy” stipulating one or more specific categories of the transmitting data being the target.

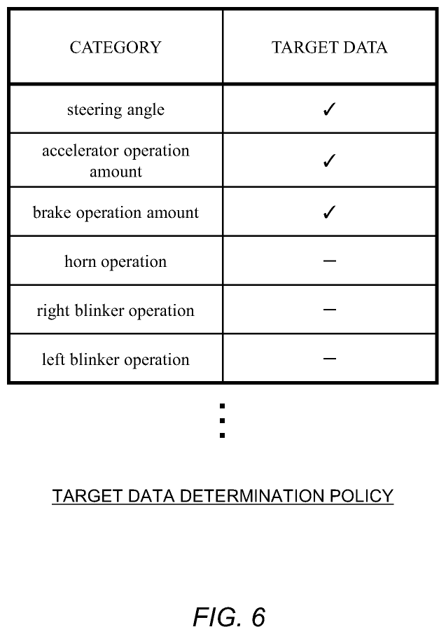

FIG. 6 illustrates an example of the target data determination policy. The one or more specific categories stipulated by the target data determination policy shown in FIG. 6 are “steering angle”, “accelerator operation amount”, and “brake operation amount”. That is, according to the target data determination policy shown in FIG. 6, the transmission hold process is executed when the transmitting data belong to the steering angle, the accelerator operation amount, or the brake operation amount. On the other hand, the transmission hold process is not executed when the transmitting data belong to the horn operation, the right blinker operation, and the left blinker operation.

The target data determination policy is given to each of the communication apparatus 110 and the communication apparatus 210 as a control program or control information, for example.

In this way, by executing the transmission hold process on the transmitting data belonging to the one or more specific categories stipulated by the target data determination policy, it is possible to prevent the transmission hold process from being unnecessarily executed on data that does not cause a problem even if the data are reversed and received on the reception side. The target data determination policy may be suitably given in accordance with an environment to which the remote driving system 10 according to the first embodiment is applied.

Although, in the above description, a case where the selected communication line is switched between the first communication line 20a and the second communication line 20b has been described as an example, it is similarly applicable to a case where the selected communication line is switched among the plurality of communication lines.

### 1-2. Configuration

Hereinafter, schematic configurations of the remote driving vehicle 100 and the remote driving apparatus 200 and schematic configurations of the communication device 110 and the communication device 210 will be described.

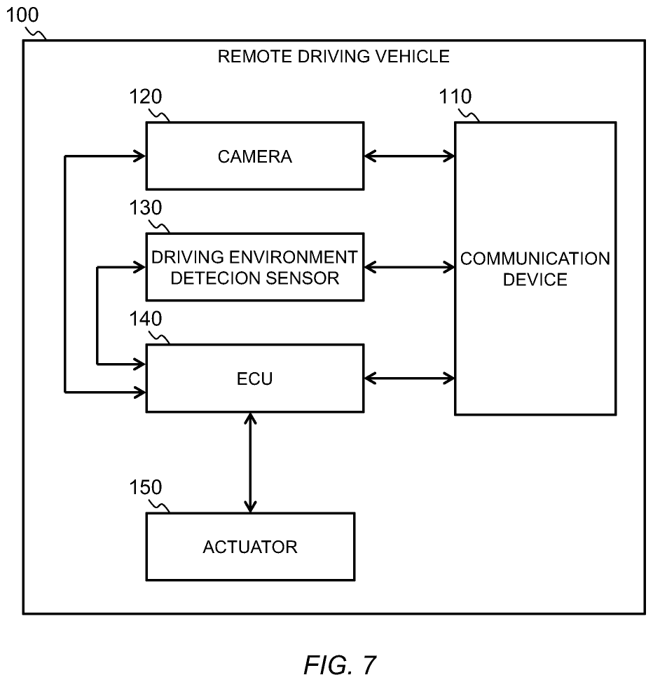

First, a schematic configuration of the remote driving vehicle 100 will be described. FIG. 7 is a block diagram showing the schematic configuration of the remote driving vehicle 100. The remote driving vehicle 100 includes a communication device 110, a camera 120, a driving environment detection sensor 130, a ECU 140, and an actuator 150. The communication device 110 is configured to be able to transmit/receive information to/from the camera 120, the driving environment detection sensor 130, and the ECU 140. The ECU 140 is configured to be able to transmit/receive information to/from the camera 120, the driving environment detection sensor 130, and the actuator 150. Typically, they are electrically connected by cable harnesses.

The camera 120 is mounted on the remote driving vehicle 100. The camera 120 captures and outputs a traveling video of the remote driving vehicle 100. The camera 120 may include a plurality of cameras capturing traveling videos in a plurality of directions with respect to the remote driving vehicle 100. The traveling video output by the camera 120 is transmitted to the communication device 110 and the ECU 140.

The driving environment detection sensor 130 is a sensor that detects information related to the driving environment of the remote driving vehicle 100 and outputs the detected information. The driving environment detection sensor 130 typically includes a traveling state detection sensor that detects a traveling state of the remote driving vehicle 100 and a surrounding environment detection sensor that detects an surrounding environment (a preceding vehicle, a white line, an obstacle, or the like) of the remote driving vehicle 100.

Examples of the traveling state detection sensor include a wheel speed sensor that detects the vehicle speed of the remote driving vehicle 100, a G sensor that detects the acceleration/deceleration of the remote driving vehicle 100, and a gyro sensor that detects the yaw rate of the remote driving vehicle 100. Examples of the surrounding environment detection sensor include a millimeter wave radar, a sonar, and a light detection and ranging (LiDAR). The detection information output by the driving environment detection sensor 130 is transmitted to the communication device 110 and the ECU 140.

The ECU 140 executes processing related to the control of the remote driving vehicle 100 based on the acquired information, and generates and outputs control signals. In particular, the ECU 140 acquires the driving operation accepted by the remote driving apparatus 200 through the communication device 110, executes processing for controlling the remote driving vehicle 100 in accordance with the driving operation. The control signals output by the ECU 140 are transmitted to the actuator 150. The control signal output by the ECU 140 may be transmitted to the communication device 110.

The actuator 150 includes, for example, an actuator that drives a power unit (an internal combustion engine, an electric motor, a hybrid engine, or the like), an actuator that drives a brake mechanism of the remote driving vehicle 100, an actuator that drives a steering mechanism of the remote driving vehicle 100, and the like. Various actuators included in the actuator 150 operate in accordance with the control signals acquired from the ECU 140, whereby control of the remote driving vehicle 100 by the ECU 140 is realized. In particular, remote driving of the remote driving vehicle 100 by the remote driving apparatus 200 is realized.

The communication device 110 transmits data to the remote driving apparatus 200 through the selected communication line by executing the transmission process. Further, the communication device 110 receives data from the remote driving apparatus 200 through the selected communication line by executing the reception process. Examples of the data transmitted by the communication device 110 include a traveling video captured by the camera 120, the detection information of the driving environment detection sensor 130, the control signal output from the ECU 140, and the like.

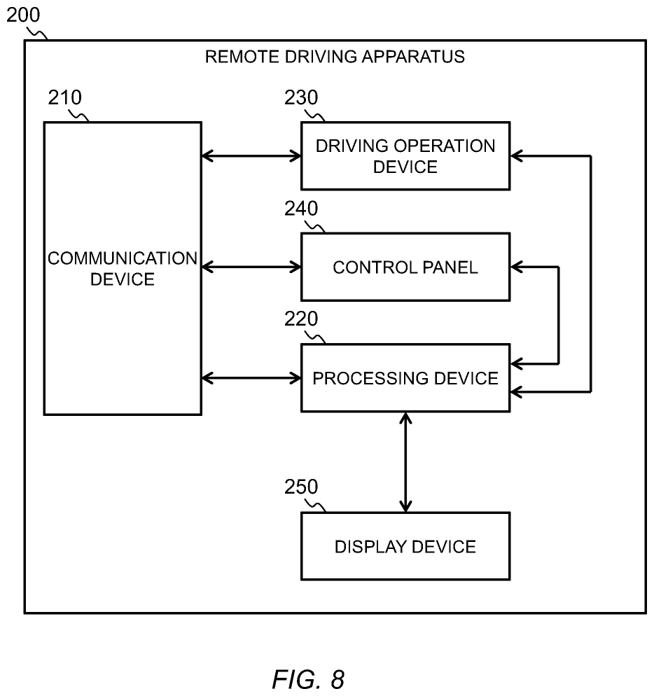

Next, a schematic configuration of the remote driving apparatus 200 will be described. FIG. 8 is a block diagram showing the schematic configuration of the remote driving apparatus 200. The remote driving apparatus 200 includes a communication device 210, a processing device 220, a driving operation device 230, a control panel 240, and a display device 250. The communication device 210 is configured to be able to transmit/receive information to/from the processing device 220, the driving operation device 230, and the control panel 240. The processing device 220 is configured to be able to transmit/receive information to/from the communication device 210, the driving operation device 230, the control panel 240, and the display device 250.

The driving operation device 230 receives a driving operation of the operator 2 and outputs driving operation information. Examples of the driving operation device 230 include a steering wheel, a gas pedal, a brake pedal, and the like. The driving operation information output by the driving operation device 230 is transmitted to the communication device 210 and the processing device 220.

The control panel 240 receives various operations other than the driving operation of the operator 2 and outputs operation information. For example, the control panel 240 receives an operation of a device provided in the remote driving vehicle 100 (turning on/off an accessory function, opening/closing of a door, lighting of a light, or the like) and switching of display of the display device 250. The control panel 240 is, for example, a switch, a touch panel, or the like. The operation information output by the control panel 240 is transmitted to the communication device 210 and the processing device 220.

The processing device 220 is a computer that executes various processes based on acquired information. In particular, the processing device 220 executes processing for controlling display of the display device 250, and generates and outputs display signals. For example, the processing device 220 generates display signals for displaying a traveling video captured by the camera 120 and detection information detected by the driving environment detection sensor 130 on the display device 250. In addition, the processing device 220 generates display signals switching the display in accordance with the operation received by the control panel 240. The display signals output by the processing device 220 is transmitted to the display device 250.

The display device 250 performs display in accordance with the display signals acquired from the processing device 220. As a result, the traveling video captured by the camera 120 and the detection information detected by the driving environment detection sensor 130 are displayed.

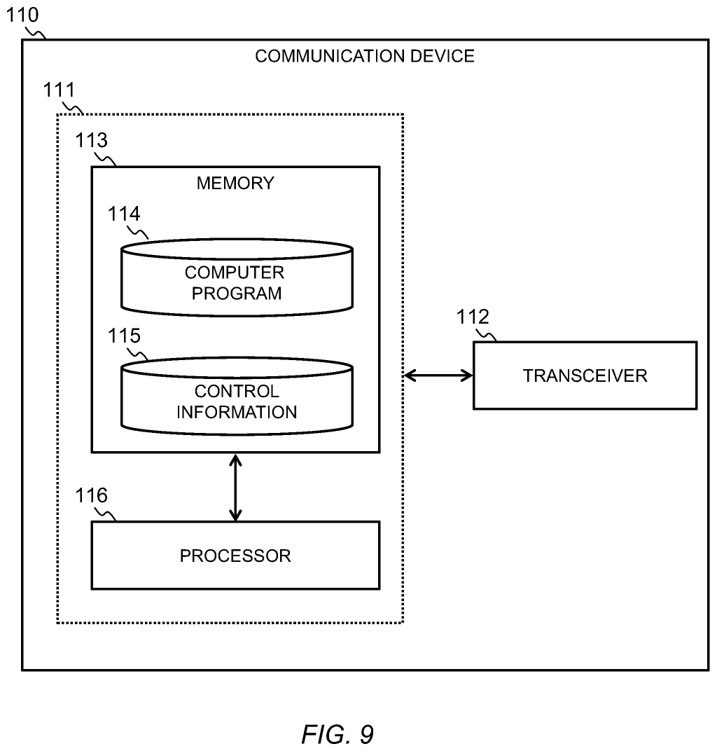

Next, a schematic configuration of the communication apparatus 110 and the communication apparatus 210 will be described. FIG. 9 is a block diagram showing the schematic configuration of the communication apparatus 110. The same configuration applies to the schematic configuration of the communication device 210.

The communication device 110 includes a memory 113 and a processor 116. The memory 113 and the processor 116 constitute the transmission/reception processing unit 111.

The memory 113 stores a computer program 114 executable by the processor 116 and control information 115 necessary for processing executed by the processor 116. Examples of the memory 113 include a volatile memory, a non-volatile memory, an HDD, an SSD, and the like.

The computer program 114 includes a program for transmitting/receiving data by the transceiver 112.

Examples of the control information 115 include information received by the communication device 110, parameter information related to the computer program 114, and the target data determination policy. The target data determination policy may be given as the computer program 114.

The processor 116 reads the computer program 114 and the control information 115 from the memory 113, and executes processing according to the computer program 114 based on the control information 115. Thus, transmission and reception of data by the transceiver 112 is realized.

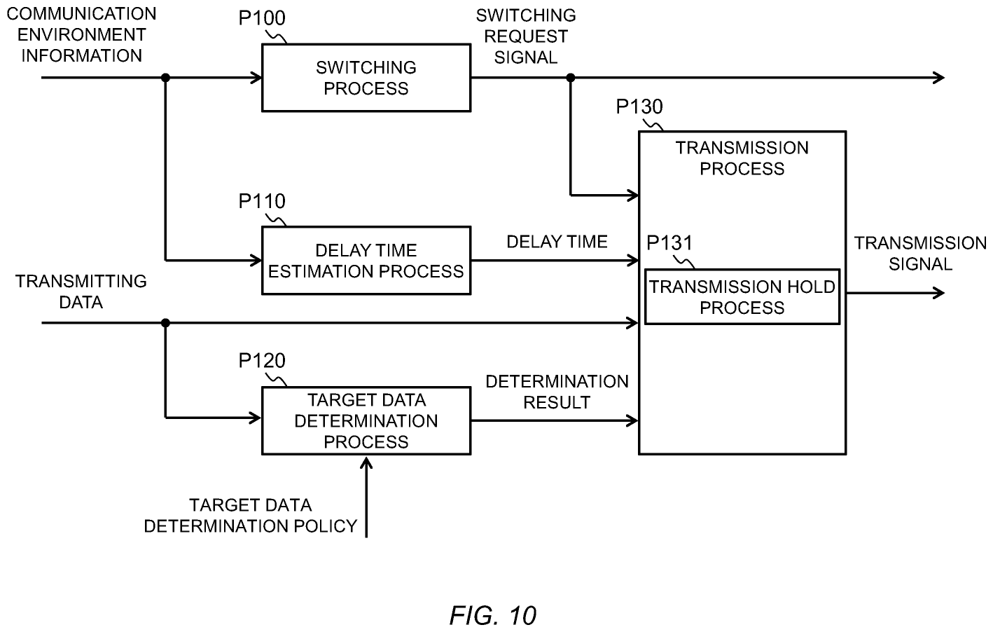

As described above, the transmission/reception processing unit 111 and the transmission/reception processing unit 211 are characterized feature in processing executed when transmitting data. FIG. 10 is a block diagram illustrating a configuration of processing executed by the transmission/reception processing unit 111 and the transmission/reception processing unit 211 when transmitting data. The processing executed, when transmitting data, by the transmission/reception processing unit 111 and the transmission/reception processing unit 211 includes a switching process P100, a delay time estimation process P110, and a target data determination process P120.

In the switching process P100, it is determined whether to switch the selected communication line based on the communication environment information. When it is determined to switch the selected communication line, a switching request signal for requesting switching of the selected communication line is generated.

In the delay time estimation process P110, the delay time of the selected communication line is estimated based on the communication environment information.

In the target data determination process P120, it is determined whether or not the transmitting data are a target time series data on which the transmission hold process P131 is executed, and a determination result is generated. Here, whether or not the transmitting data are the target time series data is determined whether the transmitting data belongs to the one or more specific categories stipulated by the target data determination policy.

In the transmission process P130, a transmission signal is generated in accordance with the transmitting data. In particular, in the transmission process P130, the transmission hold process P131 is executed when the selected communication line is switched by the switching process P100, and the transmitting data are the target time series data. When the transmission hold process P131 is executed, the delay time estimated by the delay time estimation process P110 is used as the delay time of the selected communication line.

The switching request signal and the transmission signal are transmitted to the transceiver 112 (transceiver 212). Then, in accordance with the switching request signal and the transmission signal, the transceiver 112 (transceiver 212) performs switching the selected communication line and transmitting data.

### 1-3. Communication Method

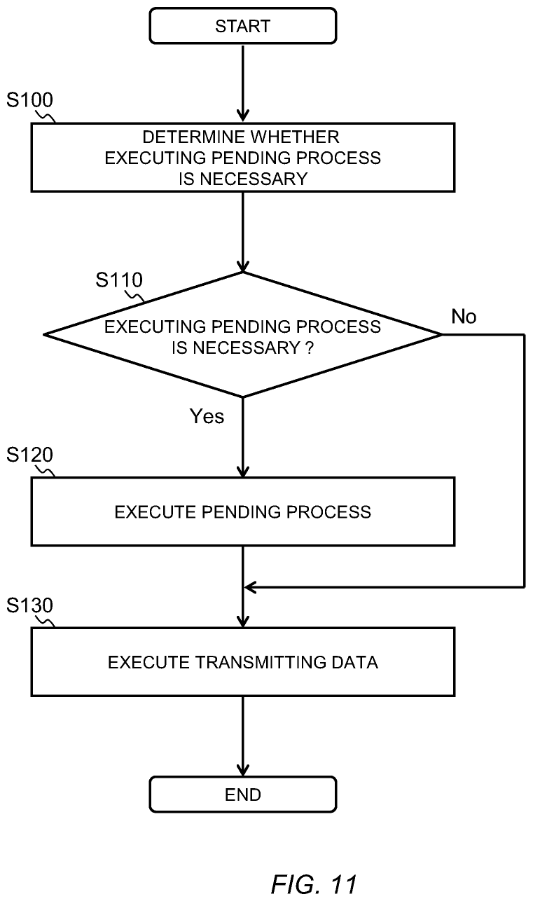

Hereinafter, a communication method between the remote driving vehicle 100 and the remote driving apparatus 200 realized in the remote driving system 10 according to the first embodiment will be described with reference to FIG. 11. The flowchart illustrated in FIG. 11 starts when the communication device 110 or the communication device 210 starts transmitting data, and each process is executed for each predetermined control period.

In step S100, it is determined whether or not executing the transmission hold process P131 is necessary for transmitting data. It is determined that the executing the transmission hold process P131 is necessary when the selected communication line is switched by the switching process P100 and the data are the target time series data, as described above.

Furthermore, the condition for executing the transmission hold process P131 may include that a change in the value of data before and after switching of the selected communication line is equal to or greater than a predetermined threshold. In this case, when the change in the value of data before and after switching is less than the predetermined threshold, the transmission hold process P131 is not executed. As a result, it is possible to prevent the transmission hold process P131 from being unnecessarily executed in a case where the change in the value of data is small and there is no problem even if the data are reversed and received on the reception side.

When the transmission hold process P131 is necessary (step S110; Yes), the transmission hold process P131 is executed (step S120) and then transmitting the data is performed (step S130). When the transmission hold process P131 is not necessary (step S110; No), transmitting the data without executing the transmission hold process P131 (step S130).

### 1-4. Effect

As described above, according to the first embodiment, when the selected communication line is switched, the transmission hold process P131 is executed for transmitting data under specific conditions. By executing the transmission hold process P131, the start of transmitting data through the communication line after switching is held off until a delay time of the communication line before switching has elapsed from a time point of switching. It is thus possible to, when time series data are transmitted, prevent that the time series data transmitted before and after switching are reversed and received on the reception side. As a result, it contributes to improvement of safety of the remote driving vehicle 100 and improvement of operability of driving operation by the operator 2.

### 1-5. Modification Example

The remote driving system 10 according to the first embodiment may be modified as follows.

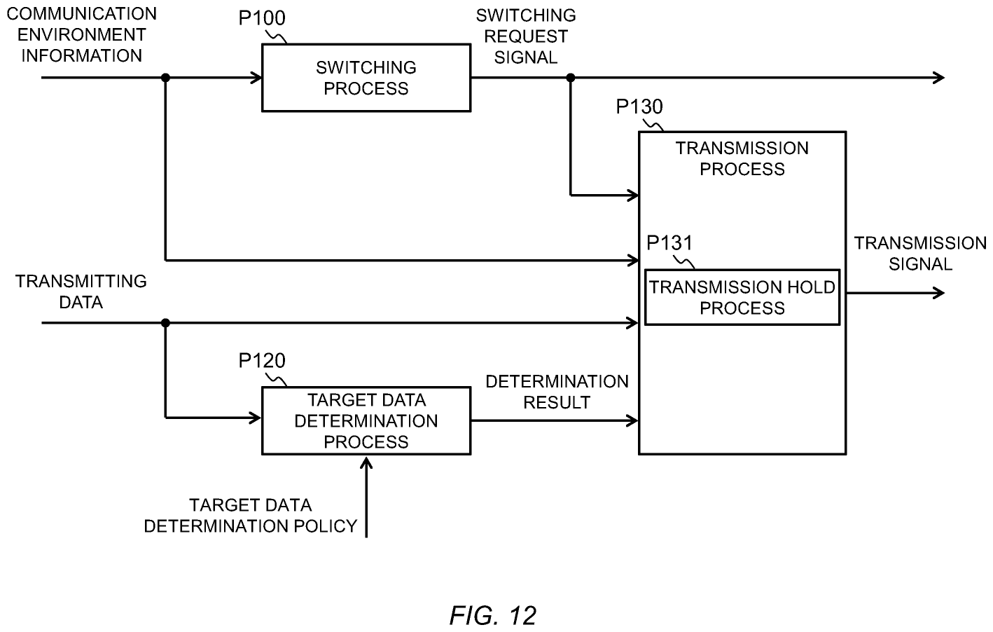

The communication device 110 and the communication device 210 are configured to acquire the RTT of the selected communication line as the communication environment information. And, in the transmission hold process P131, the delay time of the selected communication line may employ RTT/2 (half round-trip time). That is, in the modification, the time period of holding off the start of transmitting data after switching in the transmission hold process P131 is given based on the actual measurement value. Therefore, in the remote driving system 10 according to the modified example, it is not necessary to execute the delay time estimation process P110 illustrated in FIG. 10. FIG. 12 illustrates a configuration of processing executed by the transmission/reception processing unit 111 and the transmission/reception processing unit 211 according to the modification.

The remote driving system according to the modification is also possible to achieve the same effect described above.

### 2. Second Embodiment

Hereinafter, the remote driving system 10 according to the second embodiment will be described. However, contents overlapping with the matters described in the first embodiment are appropriately omitted.

In the remote driving system 10 according to the second embodiment, the transmission/reception processing unit 111 and the transmission/reception processing unit 211 are configured to execute a retransmission process when the selected communication line is switched by the switching process P100 and transmitting data are time series data. The retransmission process is a process retransmitting data transmitted during the past by a delay time difference from the time point of switching. Here, the delay time difference is a difference between a delay time of the selected communication line before switching and that after switching.

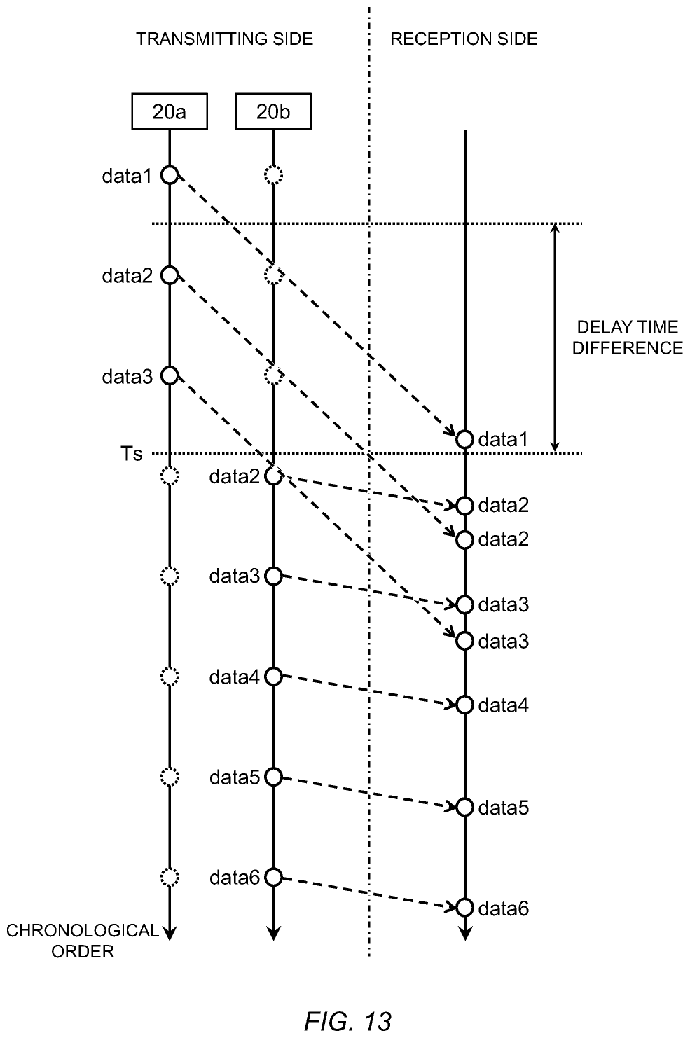

FIG. 13 is a conceptual diagram for explaining an outline of the retransmission process. FIG. 13 is a diagram similar to FIG. 3, and illustrates a case where the selected communication line is switched from the first communication line 20a to the second communication line 20b at a time point Ts. In FIG. 13, it is assumed that the transmitting data are time series data.

In FIG. 13, data transmitted during the past by the delay time difference (difference between the delay time of the first communication line 20a and the delay time of the second communication line 20b) from the time point Ts are data2 and data3. Therefore, in the example shown in FIG. 13, by executing the retransmission process, the transmission of the time series data through the second communication line 20b starts from data2.

Data (for example, data1 illustrated in FIG. 13) transmitted further in the past than a time point in the past by the delay time of the selected communication line before switching from a time point of switching is supposed to have been received at the reception side when starting the transmission through the selected communication line after switching. Furthermore, even if data transmitted during the past by the delay time of the selected communication line before switching from a time point of switching, data transmitted further in the past than a time point in the past by the delay time difference from a time point of switching is supposed to be received after switching at the reception side. Therefore, by executing the retransmission process, it is possible to prevent the time series data transmitted before and after switching from being reversed and received on the reception side.

As in the first embodiment, the transmission/reception processing unit 111 and the transmission/reception processing unit 211 may be configured to determine whether or not the transmitting data are target time series data on which the retransmission process is performed. Then, the retransmission process may be executed when determining that the transmitting data are the target time series data. Here, whether or not the transmitting data are the target series data may be determined based on the target data determination policy as in the first embodiment.

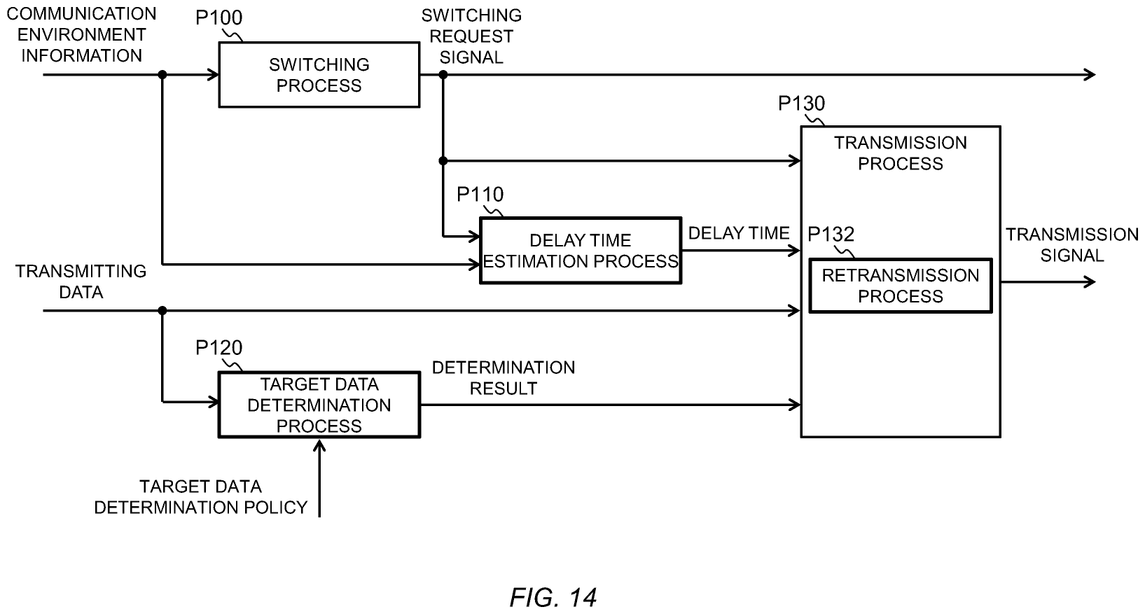

The configurations of the remote driving vehicle 100 and the remote driving apparatus 200 according to the second embodiment may be equivalent to the configurations described in the first embodiment. In addition, the configurations of the communication device 110 and the communication device 210 according to the second embodiment may be equivalent to the configurations described in the first embodiment. However, in the second embodiment, a configuration of processing executed by the transmission/reception processing unit 111 and the transmission/reception processing unit 211 when transmitting data is partially different from that in the first embodiment. FIG. 14 illustrates the configuration of processing executed when transmitting data by the transmission/reception processing unit 111 and the transmission/reception processing unit 211 according to the second embodiment.

In the target data determination process P120 according to the second embodiment, it is determined whether or not the transmitting data are the target time series data on which the retransmission process P132 is executed, and a determination result is generated. Here, whether or not the transmitting data are the target time series data is determined whether the transmitting data belongs to the one or more specific categories stipulated by the target data determination policy.

In the delay time estimation process P110, the delay time of the selected communication line is estimated. Further, in response to the switching request signal generated by the switching process P100, the delay time of the selected communication line after switching is estimated.

In the transmission process P130, based on the switching request signal and the determination result, the retransmission process P132 is executed when the selected communication line is switched by the switching process P100, and the transmitting data are the target time series data. When the retransmission process P132 is executed, the delay time estimated by the delay time estimation process P110 is used as the delay time of the selected communication line before switching and the delay time of the selected communication line after switching.

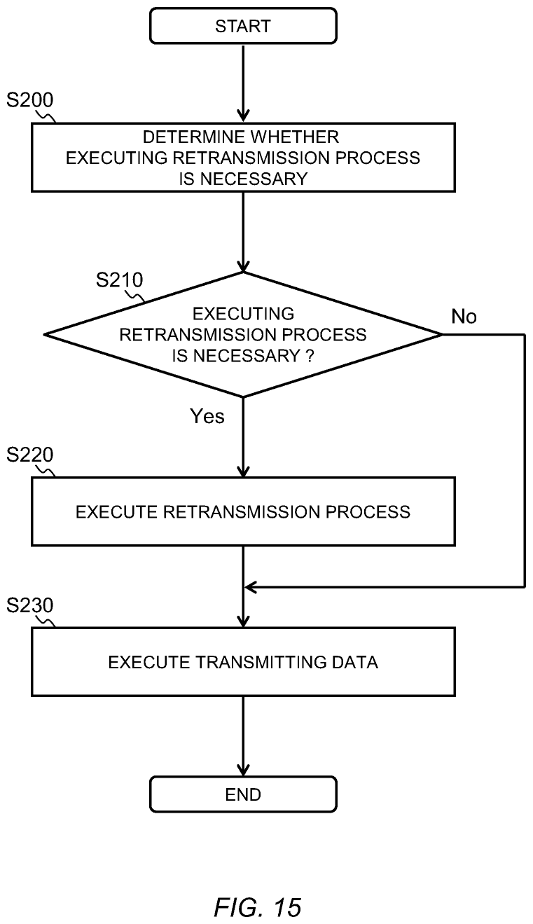

Hereinafter, a communication method between the remote driving vehicle 100 and the remote driving apparatus 200 realized in the remote driving system 10 according to the second embodiment will be described with reference to FIG. 15.

In step S200, it is determined whether or not executing the retransmission process P132 is necessary for transmitting data. It is determined that the executing the retransmission process P132 is necessary when the selected communication line is switched by the switching process P100 and the data are the target time series data, as described above. Furthermore, the condition for executing the retransmission process P132 may include that a change in the value of data before and after switching of the selected communication line is equal to or greater than a predetermined threshold.

When the retransmission process P132 is necessary (step S210; Yes), the retransmission process P132 is executed (step S220), and then transmitting the data is performed (step S230). When the retransmission process P132 is not necessary (step S210; No), transmitting the data is performed without executing the retransmission process P132 (step S230).

As described above, according to the second embodiment, when the selected communication line is switched, the retransmission process P132 is executed for transmitting data under specific conditions. By executing the retransmission process P132, the transmission of the data through the selected communication line after switching starts from data transmitted, through the selected communication line before switching, during the past by the delay time difference from a time point of switching. It is thus possible to, when time series data are transmitted, prevent that the time series data transmitted before and after switching are reversed and received on the reception side. As a result, it contributes to improvement of safety of the remote driving vehicle 100 and improvement of operability of driving operation by the operator 2.

Also in the second embodiment, a modification similar to the modification of the first embodiment can be adopted.

What is claimed is:

1. A system for providing remote driving by communication between a remote driving vehicle and a remote driving apparatus, the system comprising one or more processors configured to execute:
selecting a communication line from a plurality of communication lines capable of being formed between the remote driving vehicle and the remote driving apparatus;
transmitting time series data through the selected communication line between the remote driving vehicle and the remote driving apparatus;
acquiring a communication environment information of the selected communication line; and
switching the selected communication line based on the communication environment information,
wherein the transmitting the time series data through the selected communication line includes performing a transmission hold process when the selected communication line is switched, the transmission hold process being a process holding off start of transmitting the time series data through the selected communication line after switching until a delay time of the selected communication line before switching has elapsed from a time point of switching.

2. The system according to claim 1, wherein
the one or more processors are further configured to execute estimating the delay time of the selected communication line.

3. The system according to claim 1, wherein
the acquiring the communication environment information of the selected communication line includes acquiring a round-trip time of the selected communication line, and
the delay time of the selected communication line is half the round-trip time of the selected communication line.

4. The system according to claim 1, further comprising a memory storing information defining one or more specific categories for the time series data,
wherein the performing the transmission hold process is further conditioned on that the time series data belong to the one or more specific categories.

5. A method transmitting and receiving time series data through a selected communication line selected from a plurality of communication lines, the method including:
acquiring a communication environment information of the selected communication line;
switching the selected communication line based on the communication environment information; and
performing a transmission hold process when the selected communication line is switched, the transmission hold process being a process holding off start of transmitting the time series data through the selected communication line after switching until a delay time of the selected communication line before switching has elapsed from a time point of switching.

6. A system for providing remote driving by communication between a remote driving vehicle and a remote driving apparatus, the system comprising one or more processors configured to execute:
selecting a communication line from a plurality of communication lines capable of being formed between the remote driving vehicle and the remote driving apparatus;
transmitting time series data through the selected communication line between the remote driving vehicle and the remote driving apparatus;
acquiring a communication environment information of the selected communication line; and
switching the selected communication line based on the communication environment information,
wherein the transmitting the time series data through the selected communication line includes performing a retransmission process when the selected communication line is switched, the retransmission process being a process retransmitting the time series data transmitted during the past by a delay time difference from a time point of switching, the delay time difference being a difference between a delay time of the selected communication line before switching and that after switching.

7. The system according to claim 6, wherein
the one or more processors are further configured to execute estimating the delay time of the selected communication line.

8. The system according to claim 6, wherein
the acquiring the communication environment information of the selected communication line includes acquiring a round-trip time of the selected communication line, and
the delay time of the selected communication line is half the round-trip time of the selected communication line.

9. The system according to claim 6, further comprising a memory storing information defining one or more specific categories for the time series data,
wherein the performing the retransmission process is further conditioned on that the time series data belong to the one or more specific categories.
